(19) United States
(12) Patent Application Publication
(10) Pub. No.: US 2011/0139854 A1
(43) Pub. Date: Jun. 16, 2011

(54) SOLDERING DEVICE CLAMP

(76) Inventor: Stephen C. Custer, Naples, FL (US)

(21) Appl. No.: 12/636,950

(22) Filed: Dec. 14, 2009

(51) Int. Cl. B23K 37/04

(52) U.S. Cl. 228/44.3

(57) ABSTRACT

A clamp (2) for soldering devices (1), such as a soldering iron (17) or a soldering gun (16). The clamp has a proximal lever (5), a curved center portion (3) and a distal tip (4). The clamp is attached to the soldering device via a rotational attachment means (12), such as pivot points (13), so that when a user applies downward force to the lever of the clamp the tip of the clamp presses upward towards the tip of the soldering device, thereby allowing the user to hold multiple wires between the tip of the clamp and the tip of the soldering device. A spring (10) located in-between the clamp lever and the soldering device keeps the tip of the clamp and tip of the soldering device separated when pressure is not being applied to the lever of the clamp.

### BACKGROUND OF THE INVENTION

This invention relates to soldering devices, more particularly, a clamp for holding wires and/or electronic components in place while being soldered together that pivotally attaches to a soldering devices, such as soldering irons and soldering guns.

Soldering devices are used to make connections between wires and/or electronic components by heating solder into a liquid state on the wires and/or electronic components being connected. When using a soldering device a user must use one hand to hold the soldering device and another hand to apply the solder being heated to the wires and or electronic components being connected. However this poses a problem when a user cannot use both hands. For example, if a user is attempting to connect two loose wires together in a confined space, such as under a car dashboard or in an engine compartment, the user does not have the space or extra hand to hold the soldering device and wires in place while applying the solder to the ends of the wire.

Therefore, a need exists for a clamp that pivotally attaches to a soldering device and holds wires and/or electronic components in place while the wires are being soldered together.

The relevant prior art includes the following references:

| Pat. No. | | |
|---|---|---|
| (U.S. unless stated otherwise) | Inventor | Issue/Publication Date |
| DE202006017750 | Meltron | Feb. 08, 2007 |
| 5,145,101 | Brown et al. | Sep. 08, 1992 |
| 4,967,059 | Wagner | Oct. 30, 1990 |
| CD1,219,921 | Eisen | Mar. 31, 1987 |
| 5,591,696 | Eisen | May 27, 1986 |
| 4,507,545 | Riordan | Mar. 26, 1985 |
| 4,502,221 | Meyer | Mar. 27, 1980 |
| 4,216,894 | Gleizes | Aug. 12, 1980 |
| GB1,452,005 | Shaw | Oct. 06, 1976 |
| 3,637,120 | Clay | Jan. 25, 1972 |
| 3,521,804 | Jacobs | Jul. 28, 1970 |
| GB610,496 | Osborne | Oct. 15, 1948 |

### SUMMARY OF THE INVENTION

The primary object of the present invention is to provide a clamp for holding wires and/or electronic components against a tip of a soldering device.

Another object of the present invention is to provide a clamp for soldering devices that can be used in a confined space.

An even further object of the present invention is to provide a clamp for soldering devices that provides a strong grip for holding wires and/or electronic components in place while being soldered together.

Another object of the present invention is to provide a stand to prevent a tip of a soldering device from touching anything while the soldering device is not in use.

The present invention fulfills the above and other objects by providing a clamp that attaches to a soldering device, such as a soldering iron or a soldering gun. The clamp has a proximal lever, a curved center portion and a distal tip. The clamp is attached to the soldering device via a rotational attachment means, such as pivot points, so that when a user applies downward force to the lever of the clamp, the tip of the clamp presses upward towards the tip of the soldering device, thereby allowing the user to hold multiple wires between the tip of the clamp and the tip of the soldering device. A spring located in-between the clamp lever and the soldering device keeps the tip of the clamp and tip of the soldering device separated when downward pressure is not being applied to the lever of the clamp.

An additional feature of the clamp is a substantially Y-shaped tip that prevents the tip of the clamp from making direct contact with the tip of the soldering device when the clamp is in a closed position. The substantially Y-shaped tip provides a better grip on wires and/or electronic components being soldered together than a strait tip. An additional benefit of the substantially Y-shaped tip is that materials with low melting points, such as plastics, may be used to manufacture the clamp because the Y-shaped tip of the clamp never makes contact with the tip of the soldering device.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a soldering device with a clamp of the present invention attached thereto in an open position;

FIG. 2 is a side view of a soldering device with a clamp of the present invention attached thereto in a closed position;

FIG. 3 is a top view of a soldering device with a clamp of the present invention attached thereto;

FIG. 4 is a bottom view of a soldering device with a clamp of the present invention attached thereto having a substantially Y-shaped tip with an outer heat resistant outer layer;

FIG. 5 is a side view of a soldering device with a clamp of the present invention attached thereto; and

FIG. 6 is a top view of a soldering device with a clamp of the present invention attached thereto.

### DESCRIPTION OF THE PREFERRED EMBODIMENTS

For purposes of describing the preferred embodiment, the terminology used in reference to the numbered accessories in the drawings is as follows:
1. soldering device
2. clamp
3. curved portion
4. substantially Y-shaped tip
5. lever
6. soldering device tip
7. heating element
8. slot
9. soldering device handle
10. spring
11. heat resistant outer layer
12. rotatable attachment means
13. pivot point
14. electric wire
15. stand
16. soldering gun
17. soldering iron
18. soldering device body

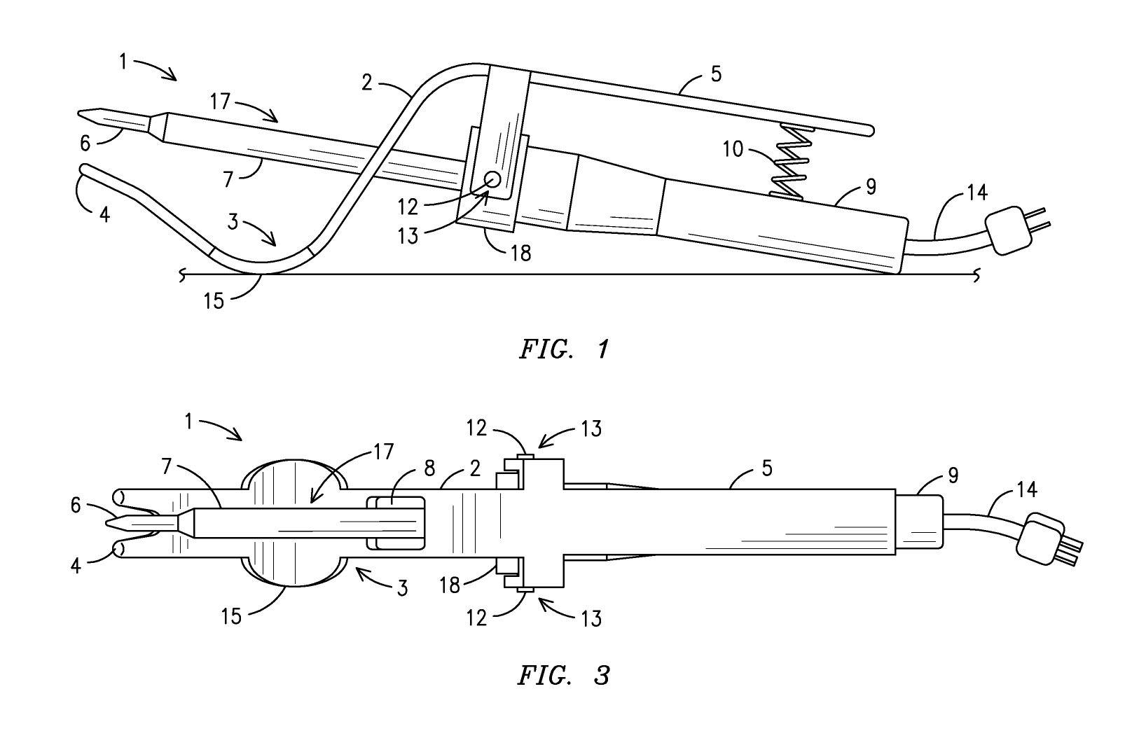

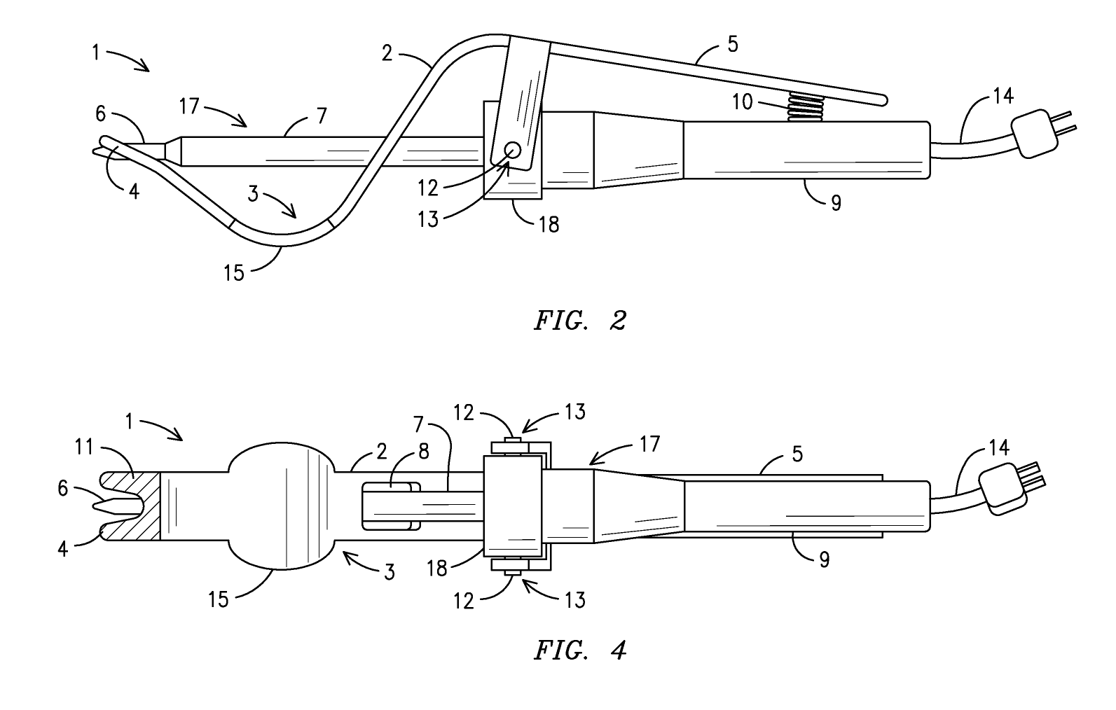

With reference to FIG. 1, a soldering device 1 with a clamp 2 of the present invention attached thereto in an open position is shown. As shown here, the soldering device is a soldering iron 17. The clamp 2 is made of a rigid material having a curved portion 3, a substantially Y-shaped tip 4 located on a distal end of the clamp, as shown further in FIGS. 3 and 4, and a proximal lever 5. A tip 6 and heating element 7 of the soldering device 1 passes through a slot 8, as shown in FIGS. 3 and 4, located in the curved portion 3 of the clamp 2, thereby allowing the substantially Y-shaped tip 4 of the clamp 2 and the clamp lever 5 to be on opposite sides of the soldering device 1. The clamp 2 is attached to a body 18 of the soldering device 1 via a rotatable attachment means 12, such as pivot points 13, which allows a user to squeeze the clamp lever 5 against handle 9 of the soldering device 1, thereby creating a scissor action that presses the substantially Y-shaped tip 4 towards the soldering device tip 6, thereby allowing a plurality of wires to be held between the substantially Y-shaped tip 4 and the soldering device tip 6 while soldering the plurality of wires together. A spring 10 located in-between the clamp lever 5 and the soldering device handle 9 keeps the substantially Y-shaped tip 4 and soldering device tip 6 separated when pressure is not being applied to the clamp lever 5. A widened portion of the clamp 2 acts as a stand 15 allowing a user to rest the soldering device 1 and clamp 2 on a surface without the soldering device tip 6 coming into contact with anything. An electric wire 14 having a wall plug that provides power to the soldering device 1 is attached to the soldering device handle 9.

With reference to FIG. 2, the soldering device 1 with a clamp 2 of the present invention attached thereto in a closed position is shown. As shown here, the soldering device is a soldering iron 17. The clamp 2 is made of a rigid material having a curved portion 3, a substantially Y-shaped tip 4, as shown further in FIGS. 3 and 4, and a lever 5. The clamp 2 is attached to a body 18 of the soldering device 1 via a rotatable attachment means 12, such as pivot points 13, which allows a user to squeeze the clamp lever 5 against handle 9 of the soldering device 1, thereby creating a scissor action that presses the substantially Y-shaped tip 4 towards the soldering device tip 6, thereby allowing a plurality of wires to be held between the substantially Y-shaped tip 4 and the soldering device tip 6 while soldering the plurality of wires together. A spring 10 located in-between the clamp lever 5 and the soldering device handle 9 keeps the substantially Y-shaped tip 4 and soldering device tip 6 separated when pressure is not being applied to the clamp lever 5, as shown in FIG. 1. A widened portion of the clamp 2 acts as a stand 15 allowing a user to rest the soldering device 1 and clamp 2 on a surface without the soldering device tip 6 coming into contact with anything. An electric wire 14 having a wall plug that provides power to the soldering device 1 is attached to the soldering device handle 9.

Now referring to FIG. 3, the soldering device 1 with a clamp 2 of the present invention attached thereto is shown. As shown here, the soldering device is a soldering iron 17. The clamp 2 is made of a rigid material having a curved portion 3 a substantially Y-shaped tip 4 and a lever 5. A tip 6 and heating element 7 of the soldering device 1 passes through a slot 8 located in the curved portion 3 of the clamp 2, thereby allowing the substantially Y-shaped tip 4 of the clamp 2 and the clamp lever 5 to be on opposite sides of the soldering device 1. The clamp 2 is attached to a body 18 of the soldering device 1 via a rotatable attachment means 12, such as pivot points 13, which allows a user to squeeze the clamp lever 5 against handle 9 of the soldering device 1, thereby creating a scissor action that presses the substantially Y-shaped tip 4 towards the soldering device tip 6. A widened portion of the clamp 2 acts as a stand 15 allowing a user to rest the soldering device 1 and clamp 2 on a surface without the soldering device tip 6 corning into contact with anything. An electric wire 14 having a wall plug that provides power to the soldering device 1 is attached to the soldering device handle 9.

Now referring to FIG. 4, the soldering device 1 with a clamp 2 of the present invention attached thereto having a substantially Y-shaped tip 4 with an outer heat resistant layer 11 is shown. As shown here, the soldering device is a soldering iron 17. The clamp 2 is made of a rigid material having a curved portion 3 a substantially Y-shaped tip 4 and a lever 5. A tip 6 and heating element 7 of the soldering device 1 passes through a slot 8 located in the curved portion 3 of the clamp 2, thereby allowing the substantially Y-shaped tip 4 of the clamp 2 and the clamp lever 5 to be on opposite sides of the soldering device 1. The clamp 2 is attached to a body 18 of the soldering device 1 via a rotatable attachment means 12, such as pivot points 13, which allows a user to squeeze the clamp lever 5 against handle 9 of the soldering device 1, thereby creating a scissor action that presses the substantially Y-shaped tip 4 towards the soldering device tip 6. An additional benefit of the substantially Y-shaped tip 4 is that materials with low melting points, such as plastics, may be used to manufacture the clamp because the substantially Y-shaped tip 4 never makes contact with the tip 6 of the soldering device 1. The substantially Y-shaped tip 4 may also be coated with an outer heat resistant outer layer 11 to prevent heat generated by the soldering device tip from melting the clamp 2. A widened portion of the clamp 2 acts as a stand 15 allowing a user to rest the soldering device 1 and clamp 2 on a surface without the soldering device tip 6 coming into contact with anything. An electric wire 14 having a wall plug that provides power to the soldering device 1 is attached to the soldering device handle 9.

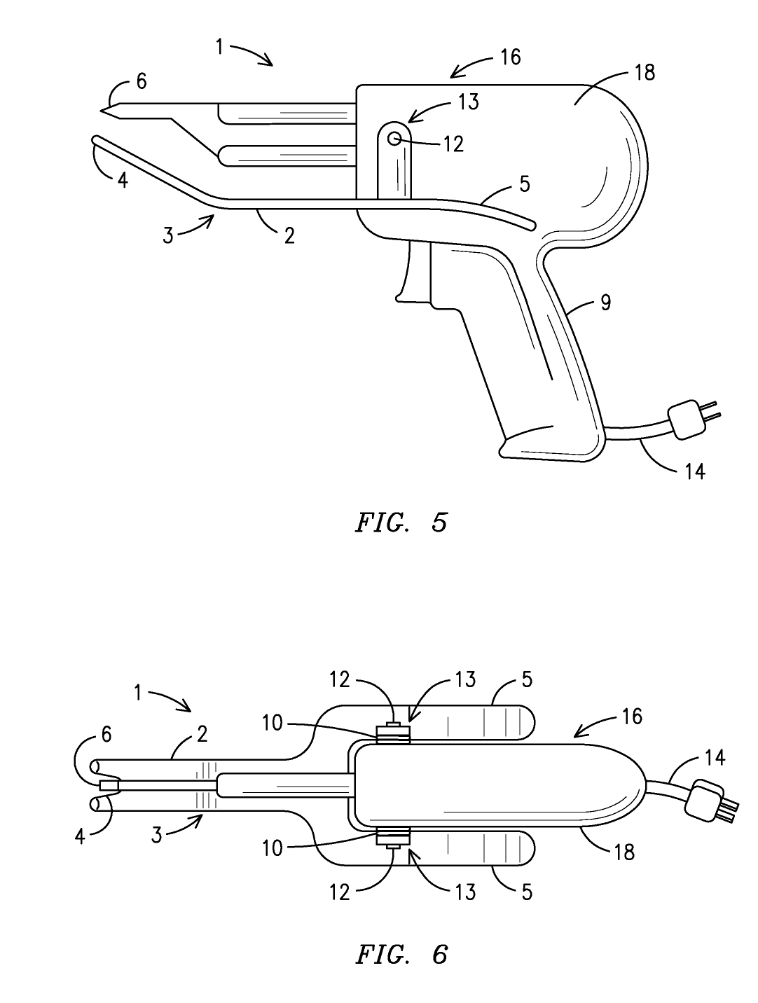

Now referring to FIG. 5, a side view of a soldering device 1 with a clamp 2 of the present invention attached thereto is shown. As shown here, the soldering device is a soldering gun 16. The clamp 2 has at least one lever 5, a curved center portion 3 and a substantially Y-shaped tip 4, as shown further in FIG. 6. The clamp 2 is attached to a body 18 of the soldering device 1 via a rotatable attachment means 12, such as a rod or screws that form pivot points 13, that allow a user to press downward on the at least one lever 5 while holding a handle 9 of the soldering device 1, thereby pressing the substantially Y-shaped tip 4 towards a tip of the soldering device 6. An electric wire 14 having a wall plug that provides power to the soldering device 1 is attached to the soldering device handle 9.

Finally referring to FIG. 6, a top view of a soldering device 1 with a clamp 2 of the present invention attached thereto is shown. The clamp 2 has at least one lever 5, a curved center portion 3 and a substantially Y-shaped tip 4. The clamp 2 is attached to a body 18 of the soldering device 1 via a rotatable attachment means 12, such as a rod or screws that form pivot points 13, that allow a user to press downward on the at least one lever 5 while holding a handle 9 of the soldering device 1, thereby pressing the substantially Y-shaped tip 4 towards a tip of the soldering device 6. A spring 10 located in-between the at least one lever 5 and the soldering device 1 keeps the substantially Y-shaped tip 4 and the soldering device tip 6 separated when pressure is not being applied to the at least one lever 5 of the clamp 2. An electric wire 14 having a wall plug that provides power to the soldering device 1 is attached to the soldering device handle 9. As shown, the clamp 2 may have a lever 5 on each side of the soldering device 1 so it may be held in either the right or left hand of a user and depressed by a user's thumb on the holder's hand.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A clamp for a soldering device having a handle, a body, a heating element, and a soldering tip, said clamp comprising:
at least one proximal lever;
at least one curved portion extending from the lever;
a tip located on a distal end of the clamp; and
a rotatable attachment means for attaching the clamp to the soldering device.

2. The clamp of 1 wherein:
said tip is substantially Y-shaped.

3. The clamp of 1 wherein:
said rotatable attachment means for attaching the clamp to the soldering device is at least one pivot point.

4. The clamp of 1 wherein:
said rotatable attachment means for attaching the clamp to the soldering device is at least one screw.

5. The clamp of 1 wherein:
said rotatable attachment means for attaching the clamp to the soldering device is at least one rod.

6. The clamp of 1 further comprising:
at least one spring located between the at least one lever and the soldering device.

7. The clamp of 1 further comprising:
a heat resistant outer layer.

8. The clamp of 1 further comprising:
a slot located in the at least one curved portion.

9. The clamp of 1 wherein:
said soldering device is a soldering iron.

10. The clamp of 1 wherein:
said soldering device is a soldering gun.

11. A clamp for a soldering device having a handle, a body, a heating element, and a soldering tip, said clamp comprising:
at least one proximal lever;
at least one curved portion extending from the lever;
a substantially Y-shaped tip located on a distal end of the clamp; and
a rotatable attachment means for attaching the clamp to the soldering device.

12. The clamp of 11 wherein:
said rotatable attachment means for attaching the clamp to the soldering device is at least one pivot point.

13. The clamp of 11 wherein:
said rotatable attachment means for attaching the clamp to the soldering device is at least one screw.

14. The clamp of 11 wherein:
said rotatable attachment means for attaching the clamp to the soldering device is at least one rod.

15. The clamp of 11 further comprising:
at least one spring located between the at least one lever and the soldering device.

16. The clamp of 11 further comprising:
a heat resistant outer layer.

17. The clamp of 11 further comprising:
a slot located in the at least one curved portion.

18. The clamp of 11 wherein:
said soldering device is a soldering iron.

19. The clamp of 11 wherein:
said soldering device is a soldering gun.
